(19) United States
(12) Patent Application Publication
(10) Pub. No.: US 2025/0122037 A1
(43) Pub. Date: Apr. 17, 2025

(54) SHEET FEEDING DEVICE AND IMAGE FORMING APPARATUS

(71) Applicant: Kentaro UJI, KANAGAWA (JP)

(72) Inventor: Kentaro UJI, KANAGAWA (JP)

(21) Appl. No.: 18/907,598

(22) Filed: Oct. 7, 2024

(30) Foreign Application Priority Data
Oct. 11, 2023 (JP) 2023-175631

(51) Int. Cl. B65H 1/26; B65H 5/36

(52) U.S. Cl. CPC B65H 1/266; B65H 5/36; B65H 2402/40

(57) ABSTRACT

A sheet feeding device includes a sheet tray, a guide, and a retracting mechanism. The sheet tray is insertable into and removable from a body of an apparatus, and has an engagement pin that protrudes in a protruding direction orthogonal to an insertion direction of the sheet tray. The engagement pin is movable in an orthogonal direction orthogonal to both the insertion direction of the sheet tray and the protruding direction of the engagement pin and is held by the sheet tray in a non-fixed manner. The guide extends in the insertion direction of the sheet tray to guide the engagement pin when the sheet tray is inserted into the body of the apparatus. The retracting mechanism retracts the engagement pin in an engaged state in the insertion direction of the sheet tray toward a specified position in the guide.

### CROSS-REFERENCE TO RELATED APPLICATION

This patent application is based on and claims priority pursuant to 35 U.S.C. § 119(a) to Japanese Patent Application No. 2023-175631, filed on Oct. 11, 2023, in the Japan Patent Office, the entire disclosure of which is hereby incorporated by reference herein.

### BACKGROUND

### Technical Field

Embodiments of the present disclosure relate to a sheet feeding device that feeds a sheet such as a sheet of paper, and an image forming apparatus, which includes the sheet feeding device, such as a copier, a printer, a facsimile machine, or a multi-functional peripheral or printing machine including at least two functions of a copier, a printer, and a facsimile machine.

### Related Art

In a sheet feeding device disposed in an image forming apparatus such as a copier, a printer, or a printing machine, a technology is widely known that inserts a sheet tray while retracting the sheet tray in an insertion direction by a retracting mechanism in order to enhance a setting property when retracting the sheet tray which can be inserted into and removed from a body of the image forming apparatus.

### SUMMARY

In an embodiment of the present disclosure, a sheet feeding device includes a sheet tray, a guide, and a retracting mechanism. The sheet tray is insertable into and removable from a body of an apparatus, and has an engagement pin that protrudes in a protruding direction orthogonal to an insertion direction of the sheet tray with respect to the body of the apparatus. The engagement pin is movable in an orthogonal direction orthogonal to both the insertion direction of the sheet tray and the protruding direction of the engagement pin and is held by the sheet tray in a non-fixed manner. The guide extends in the insertion direction of the sheet tray to guide the engagement pin when the sheet tray is inserted into the body of the apparatus. The retracting mechanism retracts the engagement pin in an engaged state in the insertion direction of the sheet tray toward a specified position in the guide.

In another embodiment of the present disclosure, an image forming apparatus includes the sheet feeding device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a schematic view of a sheet feeding device;

FIGS. 3A and 3B are perspective views of a part of a sheet tray;

FIGS. 4A and 4B are partial perspective views of a sheet feeding device, illustrating an operation of inserting a sheet tray into a retracting device of a body of an image forming apparatus;

FIG. 5 is a perspective view of an engagement pin;

FIG. 6 is a top view of a projection of a sheet tray;

FIG. 7 is a diagram illustrating a backlash between an engagement pin and a hole;

FIGS. 8A to 8D are diagrams illustrating an operation of a retracting mechanism;

FIG. 9 is a diagram illustrating a locus of an engagement pin guided by a guide;

FIGS. 10A and 10B are cross-sectional views of a sheet tray, illustrating an operation of an engagement pin in a hole when the engagement pin is guided by a guide;

FIGS. 11A and 11B are diagrams illustrating a dimensional relation between an engagement pin in a sheet tray and a guide in a body of an image forming apparatus;

FIG. 12 is a perspective view of an engagement pin according to a modification; and

FIG. 13 is a cross-sectional view of a sheet tray in which the engagement pin of FIG. 12 is disposed.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Like reference signs are assigned to like elements or components and descriptions of those elements or components may be simplified or omitted. As used herein, the singular forms “a,” “an,” and “the” are intended to include the plural forms as well, unless the context clearly indicates otherwise.

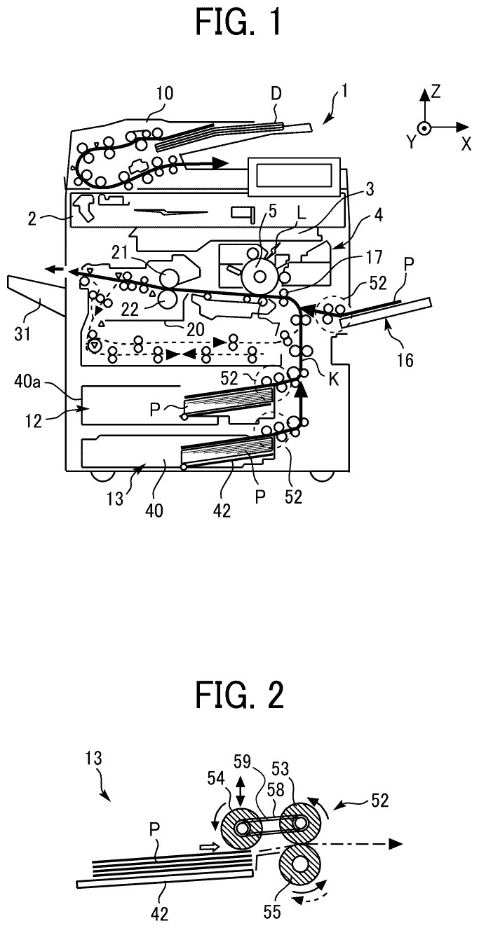

Initially with reference to FIG. 1, a description is given of the overall configuration and operation of an image forming apparatus 1 according to an embodiment of the present disclosure. In FIG. 1, the image forming apparatus 1, which is illustrated as a copier, includes a document reading device 2, an exposure device 3, an imaging device 4, and a transfer device 7 serving as an image forming unit. The document reading device 2 optically reads image data of an original document D. The exposure device 3 irradiates a photoconductor drum 5, which is included in the imaging device 4, with exposure light L according to the image data read by the document reading device 2. The imaging device 4 forms a toner image on the photoconductor drum 5. The transfer device 7 (an image forming device) transfers the toner image from the photoconductor drum 5 onto a sheet P. The image forming apparatus 1 includes a document feeder 10, which is an automatic document feeder (ADF), a sheet feeding device 12, a sheet feeding device 13, and a bypass sheet feeding device 16. The document feeder 10 conveys an original document D placed on a sheet tray to the document reading device 2. The sheet feeding devices 12 and 13 feed the sheet P stored in sheet trays 40a and 40, respectively. The sheet feeding devices 12 and 13 are in-body sheet trays placed inside a housing of the image forming apparatus 1. The bypass sheet feeding device 16 feeds the sheet P manually set by a user. The image forming apparatus 1 includes a registration roller pair 17, a fixing device 20, and an ejection tray 31. The registration roller pair 17 serving as a conveying roller pair conveys the sheet P toward the transfer device 7. The fixing device 20 includes a fixing roller 21 and a pressure roller 22 to fix the toner image (an unfixed image) on the sheet P. The sheets P are ejected from the body of the image forming apparatus 1 and stacked onto the ejection tray 31. The image forming apparatus 1 includes the sheet trays 40a and 40 disposed in the sheet feeding devices 12 and 13, respectively, and a sheet feeding mechanism 52 disposed in each of the sheet feeding devices 12, 13, and 16.

With reference to FIG. 1, a description is given of a basic image forming operation of the image forming apparatus 1. The original document D is conveyed (fed) by conveying rollers of the document feeder 10 from the document loading table in a direction indicated by the arrow in FIG. 1, and then passes over the document reading device 2. At this time, the document reading device 2 optically scans the document D passing over the document reading device 2 to read image data. The image data optically read by the document reading device 2 is converted into electrical signals. The electrical signals are transmitted to the exposure device 3 serving as a writer. The exposure device 3 then emits exposure light L, such as laser light, according to the electrical signals (i.e., image data) toward the surface of the photoconductor drum 5 disposed in the imaging device 4.

Meanwhile, while the photoconductor drum 5 rotates in a clockwise direction in FIG. 1, the imaging device 4 performs a predetermined series of image forming processes, such as a charging process, an exposing process, and a developing process, to form a toner image corresponding to the image data on the surface of the photoconductor drum 5. Thereafter, the toner image formed on the surface of the photoconductor drum 5 is transferred by the transfer device 7 as the image forming device, onto the sheet P conveyed by the registration roller pair 17.

On the other hand, a description is given of how the sheet P is conveyed to the transfer device 7 (the image forming device). One of the sheet feeding devices 12 and 13 included in the body of the image forming apparatus 1 is automatically or manually selected. For example, the lower sheet feeding device 13 is selected. A sheet feeding mechanism 52 feeds the uppermost sheet P of the sheets P such as sheets of paper stored in the sheet tray 40 of the sheet feeding device 13, and conveyed toward a sheet conveyance path K. The sheet P thus fed then passes through the sheet conveyance path K along which multiple conveying rollers are disposed and reaches the position where the registration roller pair 17 is located. When the bypass sheet feeding device 16 disposed on the side of the body of the image forming apparatus 1 is selected, the sheet P (the uppermost sheet P when a plurality of sheets P are stacked) placed on the bypass feed tray of the bypass sheet feeding device 16 by a user is fed toward the conveyance path K by the sheet feeding mechanism 52 and reaches the position of the registration roller pair 17.

The registration roller pair 17 starts rotating, and the sheet P of which the skew is corrected by the registration roller pair 17 is conveyed toward the transfer device 7 (the image forming device) in synchrony with the movement of the toner image formed on the surface of the photoconductor drum 5 so that the toner image on the sheet P is formed at the correct position.

After the transfer device 7 transfers the toner image from the photoconductor drum 5 onto the sheet P in the transfer process, the sheet P passes the position of the transfer device 7 to reach the position of the fixing device 20 along the sheet conveyance path K. In the fixing device 20, the uppermost sheet P is conveyed between the fixing roller 21 and the pressure roller 22, so that the toner image is fixed onto the sheet P under heat applied by the fixing roller 21 and pressure applied by the fixing roller 21 and the pressure roller 22 (a fixing process). After the sheet P bearing the toner image fixed in the fixing process is conveyed out from the fixing nip between the fixing roller 21 and the pressure roller 22, the sheet P is ejected from the body of the image forming apparatus 1 to the ejection tray 31 as a sheet bearing an output image. Thus, a series of the image forming processes is completed.

A description is given below of the sheet feeding device according to the present embodiment with reference to FIG. 2. Note that a description is given below of the lower sheet feeding device 13 among the plurality of sheet feeding devices 12 and 13 included in the body of the image forming apparatus 1. However, the upper sheet feeding device 12 has substantially the same structure as the lower sheet feeding device 13 except that the upper sheet feeding device 12 is located at a different position from the lower sheet feeding device 13. For this reason, the description of the upper sheet feeding device 12 is omitted.

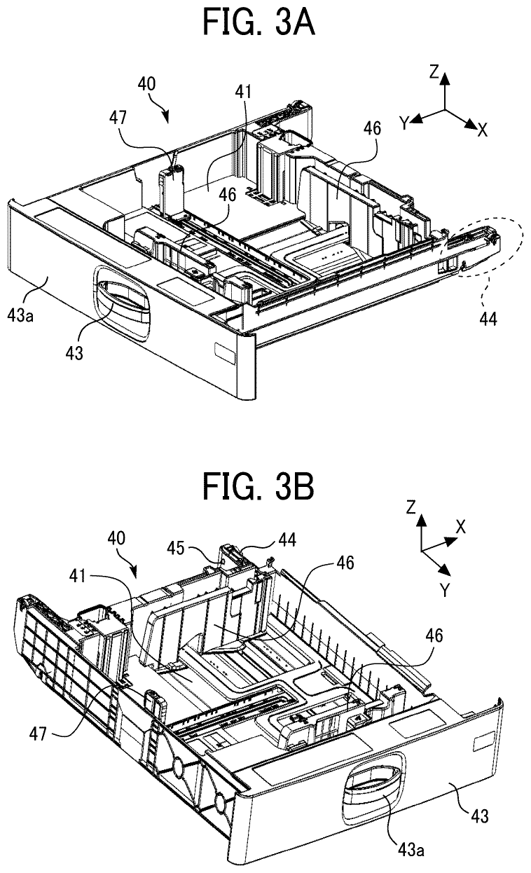

With reference to FIG. 2, the sheet feeding device 13 includes a sheet tray 40 to stack a plurality of sheets P (or one sheet P) and a body of the sheet feeding device (in the present embodiment, united with the body of the image forming apparatus 1) in which the sheet feeding mechanism 52 for feeding the sheets P stacked in the sheet tray 40 is disposed. The sheet tray 40 includes a bottom plate 42 that can be lifted and lowered, a side fence 46 movable in the width direction, and an end fence 47 movable in a sheet feed direction. A detailed description is given of the configuration and operation later with reference to FIGS. 3A and 3B.

As illustrated in FIG. 2, the sheet feeding mechanism 52 includes a sheet feed roller 53, a pickup roller 54, and a sheet separation roller 55. The sheet feed roller 53 is disposed closer to the leading end of the sheets P stacked on the bottom plate 42 and a base portion 41 (the sheet stacker) of the sheet tray 40 in the sheet feed direction (in the direction indicated by the white arrow in FIG. 2). The sheet feed roller 53 contacts the upper surface of the uppermost sheet P of the sheets P and rotates (in the counterclockwise direction in FIG. 2) along the sheet feed direction (+X direction), so that the sheet P is conveyed in the sheet feed direction indicated by the broken arrow in FIG. 2.

The pickup roller 54 rotates counterclockwise in FIG. 2 along the sheet feed direction in a state in which the pickup roller 54 contacts a surface (upper surface) of the uppermost sheet P of the sheets P stacked on the sheet tray 40 to convey the uppermost sheet P toward the position of the sheet feed roller 53. A timing belt 59 is stretched and supported by a pulley disposed on the pickup roller 54 and a pulley disposed on the sheet feed roller 53. A driving force is transmitted from a feeding motor to the pickup roller 54 via a gear train, the sheet feed roller 53, and the timing belt 59, and thus the pickup roller 54 is rotated in the counterclockwise direction in FIG. 2.

The pickup roller 54 can be contacted with and separated from the sheet P (the uppermost sheet P) of the sheets P stacked on the sheet tray 40. In other words, the pickup roller 54 is movable between a retracted position where the pickup roller 54 does not contact the sheets P stacked on the sheet tray 40 and a contact position where the pickup roller 54 contacts the sheets P stacked on the sheet tray 40. Specifically, the pickup roller 54 is held by an arm 58 to be rotatable. The arm 58 is held to be rotatable around a shaft of the sheet feed roller 53. A spring and a solenoid are coupled to the arm 58. The spring biases the pickup roller 54 so that the pickup roller 54 moves to the retracted position. The solenoid moves the pickup roller 54 to the contact position against the biasing force of the spring. When the solenoid is turned on by control of a controller, the pickup roller 54 moves to the contact position as illustrated in FIG. 2. When the solenoid is turned off by control of the controller, the pickup roller 54 moves to the retracted position. The timing belt 59 is stretched and supported by the pulley of the pickup roller 54 and the pulley of the sheet feed roller 53 even when the pickup roller 54 is contacted to and separated from the sheets P.

The sheet separation roller 55 is disposed to form a nip portion between the sheet feed roller 53 and the sheet separation roller 55. The sheet separation roller 55 rotates in a forward direction (the direction indicated by the dashed arrow in FIG. 2, and a clockwise direction) along the sheet feed direction when a single sheet P is nipped in the nip portion and when no sheet P is nipped in the nip portion. On the other hand, when multiple sheets P are nipped at the nip portion, the sheet separation roller 55 rotates in a reverse direction opposite to the forward direction described above (a direction indicated by the solid arrow in FIG. 2 and a counterclockwise direction). As a result, the uppermost sheet P of the sheets P nipped in the nip portion is fed in the sheet feed direction along the rotation of the sheet feed roller 53, and the lower sheet P is conveyed in a reverse direction opposite to the sheet feed direction (in the forward direction), so that the double feed of sheets P is prevented.

In the sheet feeding device 13 according to the present embodiment, the bottom plate 42 is lifted and lowered in the up-and-down direction depending on the number of sheets P stacked on the bottom plate 42 so that the pickup roller 54 can contact the uppermost sheet P stacked on the sheet tray 40. A sheet feeding operation of the sheets P starts after the pickup roller 54 is lowered to a position where the pickup roller 54 contacts the upper surface of the uppermost sheet P of the sheets P stacked on the bottom plate 42 whose position in the up-and-down direction has been adjusted. An entrance guide plate is disposed between the sheet tray 40 and the nip portion between the sheet feed roller 53 and the sheet separation roller 55.

In the sheet feeding device 13 having such a configuration, when no sheet P is set on the sheet tray 40, an end detection sensor disposed at the bottom portion detects that no sheet P is set on the sheet tray 40. At this time, the bottom plate 42 is in a state of being lowered to a lowermost set position (a position at which the sheet P can be set) which is largely away from the pickup roller 54. When the sheet P is set in the sheet tray 40, the end detection sensor detects the state. The controller controls the motor to lift the bottom plate 42 upward to a position (the position illustrated in FIG. 2) at which the uppermost sheet P that has been set contacts the pickup roller 54. As illustrated in FIG. 2, the pickup roller 54 starts to rotate in the counterclockwise direction while being contacted with the upper surface of the uppermost sheet P of the sheets P stacked on the bottom plate 42. At the same time, the sheet feed roller 53 and the sheet separation roller 55 start to rotate. As a result, the pickup roller 54 conveys the uppermost sheet P or upper sheets P of the sheet bundle stacked on the sheet tray 40 toward the nip portion between the sheet feed roller 53 and the sheet separation roller 55. In the nip portion, a single sheet P is separated from the other upper sheets P and is conveyed toward the image forming device. When all the sheets P stacked on the sheet tray 40 are fed and no sheet P is set on the sheet tray 40, the end detection sensor detects the state, and the controller controls a motor to lower the bottom plate 42 to the set position again.

In the present embodiment, the sheet feeding device 13 includes the body of the sheet feeding device as a device body (in the present embodiment, united with the body of the image forming apparatus 1) and the sheet tray 40 to stack multiple sheets P.

As illustrated in FIGS. 3A and 3B, the sheet tray 40 is a substantially rectangular parallelepiped member having a box shape, and includes, for example, a pair of side fences 46, the end fence 47, and the bottom plate 42 (see FIG. 2) on the base portion 41. In addition, an exterior cover 43 is disposed on +Y-directional one of the side portions of the four directions of the sheet tray 40. The exterior cover 43 includes a handle 43a. A user inserts and removes the sheet tray 40 into and from the body of the image forming apparatus 1 (apparatus body) in ±Y directions while gripping the handle 43a. Specifically, the sheets P are stacked in the sheet tray 40 in a state where the sheet tray 40 is retracted in the +Y direction (removal direction or retracting direction) with respect to the body of the image forming apparatus 1. Thereafter, the sheet tray 40 is attached to the −Y direction (insertion direction or attaching direction) with respect to the body of the image forming apparatus 1. Such an insertion-and-removal operation (attachment-and-detachment operation) is performed every time the sheet P is set (replenished) in the sheet tray 40.

The sheet tray 40 includes a pair of side fences 46 and one end fence 47 to surround a space (a space in which the sheets P are stacked) above (±Z directions) the base portion 41 and the bottom plate 42 (see FIG. 2) with three sides except for the downstream side in the sheet feed direction (+X direction).

The side fences 46 function as sheet restricting members that restrict the position of the sheets P stacked on the sheet tray 40 in the width direction (±Y directions). The side fences 46 are disposed at both ends in the width direction to sandwich the sheet P and are movable in the width direction in accordance with the size of the sheet P in the width direction. The side fence 46 is manually moved in the width direction along a guide rail to determine the posture of the sheet P in the width direction in the sheet tray 40. Accordingly, the sheet P whose position in the width direction is determined is smoothly fed from the sheet tray 40. In the present embodiment, a pair of side fences 46 increase and decrease the distance between the pair of side fences 46 in the width direction in conjunction with each other. In other words, when one of the side fences 46 is manually moved in the +Y direction, the other side fence 46 is moved in the −Y direction in conjunction with the one side fence 46, and when the one side fence 46 is manually moved in the −Y direction, the other side fence 46 is moved in the +Y direction in conjunction with the one side fence 46. As a moving mechanism for interlocking the pair of side fences 46, a pinion-and-rack mechanism including a rack gear portion, another rack gear portion, and a pinion gear can be used. The rack gear portion is united to extend in the width direction perpendicular to one side fence 46. The other rack gear portion is united to extend in the width direction perpendicular to the other side fence 46. The pinion gear is interposed between the rack gear portions and engaged with the rack gear portions.

The end fence 47 functions as a sheet restricting member that restricts the position of the sheets P stacked on the sheet tray 40 on the upstream side in the sheet feed direction (which is −X direction and is closer to the trailing end of the sheet P). The end fence 47 is disposed to contact the trailing end of the sheet P in the sheet feed direction and is movable in the sheet feed direction in accordance with the size of the sheet P in the sheet feed direction. The end fence 47 is manually moved in the width direction along the guide rail to determine the posture of the sheet P in the sheet feed direction in the sheet tray 40. Accordingly, the sheet P whose position in the sheet feed direction is determined is smoothly fed from the sheet tray 40.

Hereinafter, with reference to FIGS. 3A to 11B, a description is given of a configuration and operation of the sheet feeding device 13 (image forming apparatus 1) according to the present embodiment. As described above with reference to FIGS. 3A and 3B, the sheet feeding device 13 according to the present embodiment includes the sheet tray 40 that can be inserted into and removed from the body of the image forming apparatus 1 as an apparatus body.

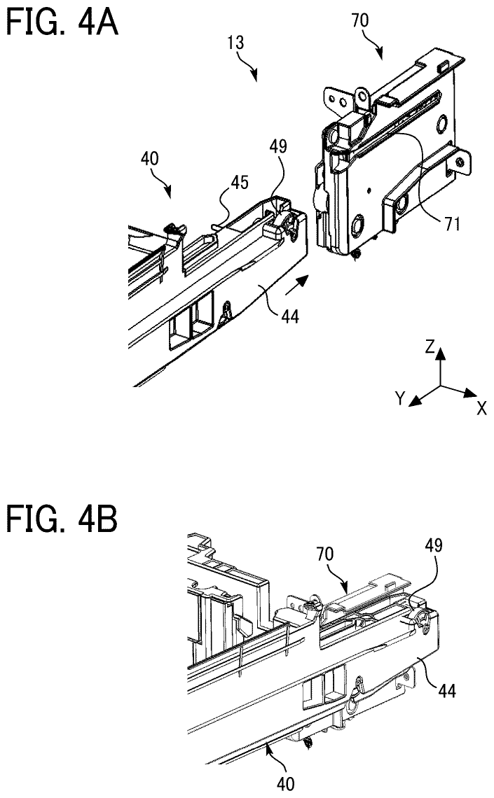

With reference to FIGS. 3B, 4A, and 6, the sheet tray 40 in the present embodiment includes an engagement pin 45 that protrudes in a protruding direction (−X direction) orthogonal to an insertion direction (−Y direction) with respect to the body of the image forming apparatus 1 (the apparatus body). Specifically, as illustrated in FIGS. 3A, 3B, 4A, and 4B, the sheet tray 40 has a projection 44 that protrudes in the insertion direction (−Y direction) on the downstream side in the insertion direction (−Y direction) at an end in the protruding direction (in the width direction and −X direction).

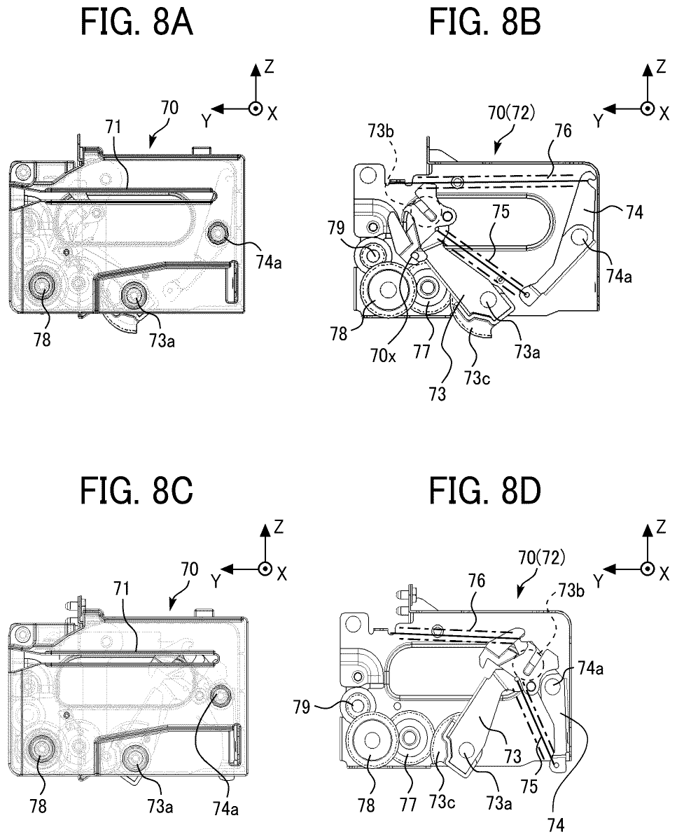

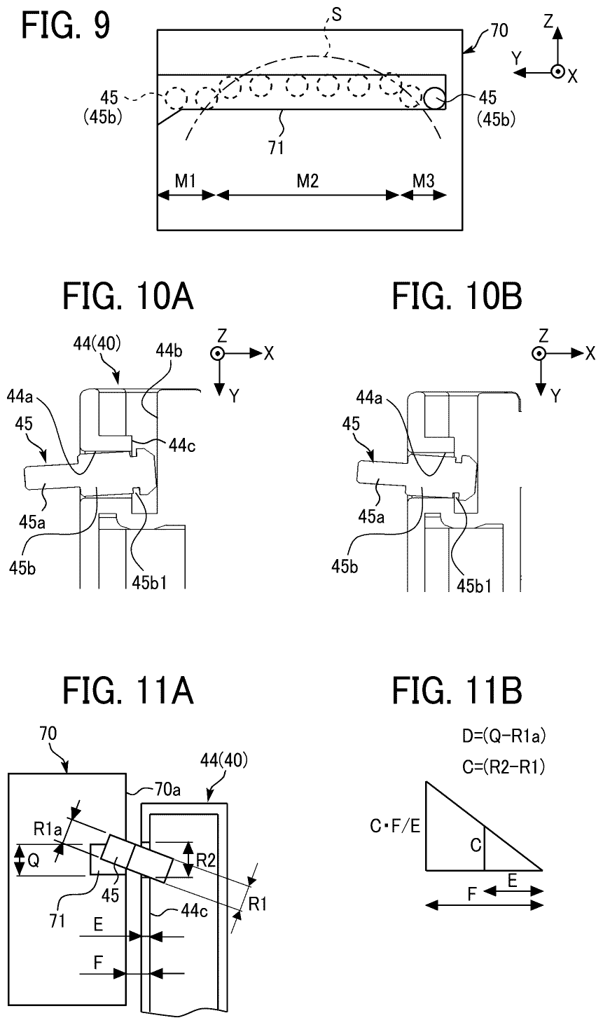

More specifically, the projection 44 is a portion formed so that an end in the width direction of a box-shaped portion (in which, for example, the base portion 41, the side fences 46, the end fence 47, and the bottom plate 42 are disposed) surrounded on four sides extends in the −Y direction in the sheet tray 40. The sheet tray 40 is inserted into and removed from the body of the image forming apparatus 1 while the end in the width direction including the projection 44 slides on a rail formed in the body of the image forming apparatus 1. In the present embodiment, the engagement pin 45 is disposed on the projection 44 and protrudes in the horizontal direction toward the center (−X direction) in the width direction. The engagement pin 45 is positioned at a specified position (positioning position) after being retracted by a retracting unit 70 (see FIGS. 4A, 4B, 8A, 8B, 8C, and 8D) to be described later when the sheet tray 40 is inserted (mounted) into the body of the image forming apparatus 1. A detailed description is given of the configuration later with reference to FIGS. 8A, 8B, 8C, 8D, and 9. The engagement pin 45 in the present embodiment is not held by the projection 44 of the sheet tray 40 in a fixed manner, but is held by the projection 44 of the sheet tray 40 in a non-fixed manner so that the engagement pin 45 is movable. A detailed description is also given of the configuration later with reference to FIGS. 6, 7, and 9 to 11B.

With reference to FIGS. 4A and 4B, the projection 44 in the present embodiment includes a roller 49 for smoothly inserting and removing the sheet tray 40 into and from the body of the image forming apparatus 1 (the rail). A positioning pin that can be fitted into a positioning hole formed in the body of the image forming apparatus 1 is disposed in the front face of the sheet tray 40 (on the side where the exterior cover 43 is disposed). The sheet tray 40 has a projection that protrudes in the insertion direction on the other end in the width direction, separately from the projection 44 on one end in the width direction where the engagement pin 45 is disposed. The sheet tray 40 is inserted into and removed from the body of the image forming apparatus 1 in a well-balanced manner while the portion on the other end in the width direction including the projection slides on a rail formed in the body of the image forming apparatus 1.

On the other hand, with reference to FIGS. 4A, 4B, 8A, 8B, 8C, 8D, and 9, the body of the image forming apparatus 1 as an apparatus body includes, for example, a guide 71, a retracting mechanism 72 (73 to 78), and a damper 79. The guide 71 is a groove that guides the engagement pin 45 when the sheet tray 40 is inserted into the body of the image forming apparatus 1 and extends in the insertion direction (±Y directions). The guide 71 (groove) has a configuration in which the up-and-down direction (the orthogonal direction orthogonal to the insertion direction and the protruding direction, and ±Z directions) is the groove width direction. The retracting mechanism 72 is a mechanism for retracting the engagement pin 45 in the insertion direction (−Y direction) toward a specified position (the position indicated by a solid line in FIG. 9 and a positioning position) in the guide 71 in a state where the engagement pin 45 is engaged. The damper 79 is a member for softening an impact when the sheet tray 40 contacts the retracting unit 70 when the sheet tray 40 is inserted into the body of the image forming apparatus 1.

Specifically, with reference to FIGS. 8A, 8B, 8C, and 8D, a substantially rectangular retracting unit 70 is fixed and disposed on a body side plate on the downstream side in the insertion direction (the rear side in the mounting direction) of the body of the image forming apparatus 1. The retracting unit 70 has a guide 71 formed on one side surface (the side surface on one end in the width direction, which is an opposing surface facing the engagement pin 45 of the projection 44), and the retracting mechanism 72 is disposed (on the side surface facing the center in the width direction) inside the retracting unit 70. The guide 71 communicates with the inside of the retracting unit 70 and is formed such that the engagement pin 45 inserted into the guide 71 engages with an engagement groove 73b of a first arm 73 to be described later. The retracting mechanism 72 includes the first arm 73 and a second arm 74 as arms, a first tension spring 75 and a second tension spring 76 as biasing members, a gear 77, and a gear 78. The arm (first arm 73) has the engagement groove 73b with which the engagement pin 45 is engaged to be freely movable and is rotatable around a fulcrum (a support shaft 73a) away from the guide 71. The first tension spring 75 and the second tension spring 76 function as biasing members that bias the first arm 73 and the second arm 74 so that the engagement pin 45 in a state of being engaged with the engagement groove 73b is retracted in the insertion direction (−Y direction).

More specifically, the first arm 73 is disposed to be rotatable around the support shaft 73a as a fulcrum. The first arm 73 has a gear 73c (which is engaged with gear trains 77 and 78 disposed in the retracting unit 70) around the support shaft 73a at a root portion. The first arm 73 has the engagement groove 73b with which the engagement pin 45 can be engaged (the engagement pin 45 is formed in a notched shape to be swingable) and a hook portion that can be fitted to a lock pin 70x (disposed on the side surface of the retracting unit 70) at a tip portion. The second arm 74 is disposed to be rotatable around a support shaft 74a. One end of the first tension spring 75 is coupled to one end of the second arm 74. The other end of the first tension spring 75 is coupled to the first arm 73. One end of the second tension spring 76 is coupled to the other end of the second arm 74. The other end of the second tension spring 76 is coupled to the housing of the retracting unit 70.

In the retracting mechanism 72 with such a configuration, in a state where the sheet tray 40 is retracted from the body of the image forming apparatus 1, as illustrated in FIGS. 8A and 8C, the engagement groove 73b of the first arm 73 is on standby on the upstream side (left in FIGS. 8A and 8C) in the insertion direction of the guide 71 in a state where the first arm 73 is locked by the lock pin 70x. At this time, the first arm 73 is applied with the biasing force in the retracting direction by the first tension spring 75 and the second tension spring 76 via the second arm 74. However, the standby state illustrated in FIG. 8D is maintained by the locking force of the first arm 73 by the lock pin 70x and the load resistance via the gear trains 77 and 78. When the sheet tray 40 is inserted into the body of the image forming apparatus 1 and the engagement pin 45 of the sheet tray 40 (the projection 44) engages with the engagement groove 73b of the first arm 73, the locking state of the first arm 73 by the lock pin 70x is released by the pressing at that time. Accordingly, the engagement pin 45 (the sheet tray 40) is retracted by the first arm 73 to the right (−Y direction) of FIGS. 8A to 8D in a state where the engagement pin 45 is engaged with the engagement groove 73b by the biasing force in the retracting direction by the first tension spring 75 and the second tension spring 76 via the second arm 74. At this time, as illustrated by the dashed line in FIG. 9, the engagement pin 45 moves in the insertion direction (−Y direction) from the left to the right of FIGS. 8A to 8D in the guide 71. Finally, the retracting mechanism 72 takes the posture as illustrated in FIGS. 8B and 8D, so that the engagement pin 45 reaches a specified position (a desired position illustrated by the solid line in FIG. 9), and the sheet tray 40 contacts the body side plate on the rear side of the body of the image forming apparatus 1 in the insertion direction, and thus the set position of the sheet tray 40 in the body of the image forming apparatus 1 is determined. When the sheet tray 40 is retracted from the body of the image forming apparatus 1, an operation opposite to the operation at the time of insertion described above is performed.

With reference to FIGS. 10A and 10B, in the present embodiment, the engagement pin 45 is held by the sheet tray 40 (the projection 44) in a non-fixed manner to be movable (freely movable) in an orthogonal direction (in the present embodiment, the up-and-down direction (±Z directions)) orthogonal to the insertion direction (the insertion direction of the sheet tray 40 and the −Y direction) and the protruding direction (the direction in which the engagement pin 45 protrudes and the −X direction). In other words, the engagement pin 45 is not fixed and held by the sheet tray 40 (the projection 44), but is loosely held so that the posture is not fixed.

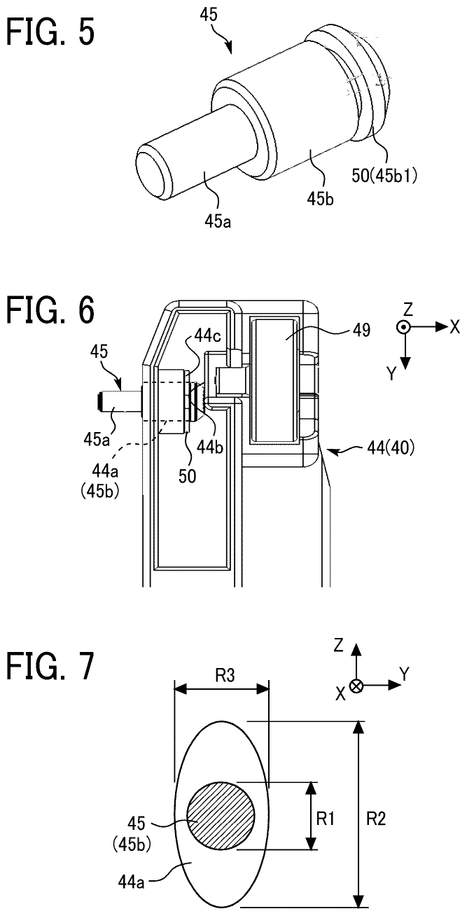

Specifically, with reference to FIGS. 5, 6, 10A, and 10B, the sheet tray 40 has a hole 44a into which a large-diameter portion 45b serving as an insertion portion of the engagement pin 45 is inserted. The sheet tray 40 holds the engagement pin 45 to be inclined with respect to the protruding direction (±X directions) and to be slidable in the orthogonal direction (±Z directions) in a state where a clearance in the ±Z directions (orthogonal direction orthogonal to the insertion direction and the protruding direction) is formed between the large-diameter portion 45b (insertion portion) and the hole 44a. In other words, the large-diameter portion 45b (insertion portion) and the hole 44a are configured to have a backlash at least in the ±Z directions. The sheet tray 40 holds the engagement pin 45 to be inclined with respect to the protruding direction (±X directions) and to be slidable in the insertion direction (±Y directions) in a state where a clearance in the insertion direction (±Y directions) is formed between the large-diameter portion 45b (insertion portion) and the hole 44a. In other words, the large-diameter portion 45b (insertion portion) and the hole 44a are configured to have a backlash in the ±Y directions. However, the hole 44a of the projection 44 is formed such that the clearance (backlash) in the insertion direction (±Y directions) described above is smaller than the clearance (backlash) in the orthogonal direction (±Z directions) described above.

Specifically, as illustrated in FIG. 7, the hole 44a is an oval hole (or an elongated hole) in which the ±Z directions (orthogonal directions) are the longitudinal directions and the ±Y directions (insertion directions) are the lateral directions. In other words, when a hole diameter of the hole 44a in the longitudinal direction (±Z directions) is R2, a hole diameter of the hole 44a in the lateral direction (±Y directions) is R3, and an outer diameter of the large-diameter portion 45b (insertion portion) of the engagement pin 45 is R1, a relation of R2−R1>R3−R1 is established.

As described above, in the sheet feeding device 13 according to the present embodiment, the engagement pin 45 guided by the guide 71 while being retracted by the retracting mechanism 72 is directly and loosely held in the sheet tray 40 (projection 44) to be movable with a backlash at least in the ±Z directions. Accordingly, in the sheet feeding device 13 according to the present embodiment, the number of components is reduced and the configuration can be simplified compared to the case where the engagement pin 45 is held in the sheet tray 40 via another member such as a holding arm. As a result, the apparatus is less likely to be increased in cost and size.

When the engagement pin 45 moves in the insertion direction (−Y direction) while being guided by the guide 71, the resistance when the engagement pin 45 slides on the guide 71 is unlikely to increase, and the setting property of the sheet tray 40 to the body of the image forming apparatus 1 is enhanced. Specifically, in the retracting mechanism 72 according to the present embodiment, as described above with reference to FIGS. 8A to 8D, the first arm 73 with which the engagement pin 45 engages rotates around the support shaft 73a which is downwardly away from the guide 71. In other words, if the engagement pin 45 is held in a state of being fixed to the sheet tray 40, the retracting mechanism 72 retracts the engagement pin 45 in an engaged state while drawing an arc-shaped trajectory S (see FIG. 9) around a fulcrum (support shaft 73a) away from the guide 71. Accordingly, if the engagement pin 45 is held in a state of being fixed to the sheet tray 40 with such a configuration, even if the engagement pin 45 slightly moves in the engagement groove 73b, a large sliding resistance is generated between the engagement pin 45 and the guide 71 in a certain region in the process in which the engagement pin 45 moves in the guide 71 in the −Y direction, and thus the setting property of the sheet tray 40 deteriorates (the retracting load by the retracting mechanism 72 increases). On the other hand, in the present embodiment, the engagement pin 45 is not fixed to the sheet tray 40 and is held to be movable with a backlash at least in the ±Z directions. Accordingly, even if a large sliding resistance is likely to be generated between the engagement pin 45 and the guide 71 in a certain region in the process in which the engagement pin 45 moves in the −Y direction along the guide 71, the engagement pin 45 changes the posture by being inclined or sliding, so that the occurrence of such a large sliding resistance can be reduced. Accordingly, the setting property of the sheet tray 40 is enhanced (the retracting load by the retracting mechanism 72 is reduced). With substantially the same mechanism, when the sheet tray 40 is retracted from the body of the image forming apparatus 1, the sliding resistance between the engagement pin 45 and the guide 71 is reduced, and the retracting property (operation property at the time of retracting) of the sheet tray 40 is enhanced.

Specifically, with reference to FIGS. 9, 10A, and 10B, in the process in which the engagement pin 45 moves in the −Y direction along the guide 71, the tip end of the engagement pin 45 is inclined downward to the left in the range M1 of FIG. 9 as illustrated in FIG. 10A, the tip end of the engagement pin 45 is inclined upward to the left in the range M2 as illustrated in FIG. 10B, and the tip end of the engagement pin 45 is inclined downward to the left in the range M3 again as illustrated in FIG. 10A.

As described above, in the present embodiment, in order to efficiently obtain the effect of reducing the sliding resistance between the engagement pin 45 and the guide 71 having the groove width direction in the ±Z directions, the clearance (R2−R1) between the engagement pin 45 and the hole 44a in the ±Z directions is set to be large. However, in order to further exhibit the effect of reducing the sliding resistance described above, a clearance (R3−R1) in the ±Y directions between the engagement pin 45 and the hole 44a is also provided. However, if the clearance in the ±Y directions is set to be large, the distance when the sheet tray 40 is retracted to the specified position needs to be set to be large by that amount, and thus the apparatus is increased in size. Accordingly, in the present embodiment, the clearance in the ±Y directions is set to be smaller than the clearance in the ±Z directions.

With reference to FIG. 5, in the present embodiment, the engagement pin 45 has a small-diameter portion 45a guided by the guide 71 and the large-diameter portion 45b as an insertion portion inserted into the hole 44a and having an outer diameter larger than the outer diameter of the small-diameter portion 45a. A retaining ring 50 as a restricting member that restricts the movement of the engagement pin 45 in the protruding direction (−X direction) of the engagement pin 45 is disposed on the large-diameter portion 45b. The retaining ring 50 as a restricting member has an outer diameter larger than the large-diameter portion 45b and larger than the outer diameter of the hole 44a (outer diameter R3 in the lateral direction) and is disposed in a circumferential groove 45b1 (see FIGS. 10A and 10B) formed in the large-diameter portion 45b. The retaining ring 50 is assembled to be fitted into the circumferential groove 45b1 from above the projection 44 (which is an open space) after the engagement pin 45 in a state where the retaining ring 50 is not attached is inserted into the hole 44a from the left in FIG. 6. With such a configuration, even if the engagement pin 45 is retracted in the −X direction, the retaining ring 50 is caught by the edge (an inner wall 44c) around the hole 44a, and thus the engagement pin 45 cannot be pulled out. Accordingly, the engagement pin 45 is prevented from falling off in the −X direction.

With reference to FIGS. 6, 10A, and 10B, the sheet tray 40 (projection 44) has a restricting portion 44b that restricts the movement in the direction (+X direction) opposite to the protruding direction of the engagement pin 45. The restricting portion 44b is a wall formed inside (hollow portion) of the projection 44 and is formed so that the engagement pin 45 (end of the large-diameter portion 45b) can contact the restricting portion 44b. With such a configuration, even if the engagement pin 45 is pushed in the +X direction, the large-diameter portion 45b of the engagement pin 45 contacts the restricting portion 44b, and thus the engagement pin 45 cannot be pushed in any further. Accordingly, an inconvenience that the engagement pin 45 is buried in the +X direction is prevented.

With reference to FIG. 11A, in the present embodiment, when a clearance between the engagement pin 45 (large-diameter portion 45b) and the hole 44a in the ±Z directions (orthogonal directions) is C (=R2−R1), a clearance between the engagement pin 45 (small-diameter portion 45a having an outer diameter Ria) and the guide 71 (having a groove width Q) in the ±Z directions (orthogonal directions) is D (=Q−R1a), a relation of D<C is established. Such a configuration can sufficiently ensure the free movement of the engagement pin 45 in the ±Z directions. Accordingly, the effect of reducing the sliding resistance between the engagement pin 45 and the guide 71 having the groove width direction in the ±Z directions is easily exhibited. FIG. 11A illustrates the shape of the engagement pin 45, the projection 44, and the retracting unit 70 in a simplified manner for ease of understanding.

With reference to FIG. 11A, in the present embodiment, when the hole depth of the hole 44a is E and the distance from the inner wall 44c of the sheet tray 40 where the hole 44a is formed to an outer wall 70a (lateral surface) of the retracting unit 70 (the body of the image forming apparatus 1) where the guide 71 is formed is F, a relation of D<C×F/E is established. With reference to FIG. 11B, the value of C×F/E in the formula described above is the maximum amount (the amount of displacement absorption due to inclination) that the engagement pin 45 can be inclined at the position of the guide 71 (outer wall 70a). Accordingly, when the above-described formula is established, the free movement (the amount of inclination) of the engagement pin 45 can be sufficiently ensured. Accordingly, the effect of reducing the sliding resistance between the engagement pin 45 and the guide 71 is more efficiently exhibited without unnecessarily increasing the clearance C (backlash).

### Modification

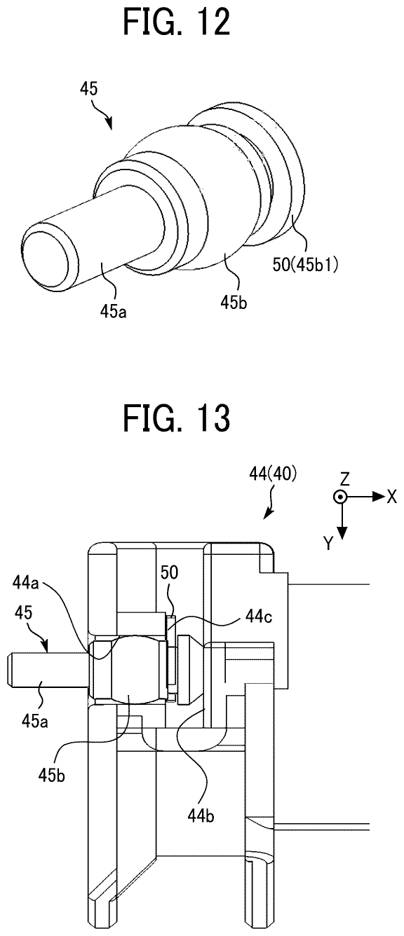

As illustrated in FIGS. 12 and 13, the engagement pin 45 according to the modification has the large-diameter portion 45b (insertion portion) to be inserted into the hole 44a. The large-diameter portion 45b has a drum shape. In other words, the large-diameter portion 45b (insertion portion) has a curved shape such that the outer circumferential surface of the large-diameter portion 45b bulges outward. When the engagement pin 45 is guided by the guide 71, such a configuration can reduce the contact area of the engagement pin 45 with the guide 71, so that the sliding resistance between the engagement pin 45 and the guide 71 is further reduced. Accordingly, the setting property of the sheet tray 40 is further enhanced (the retracting load by the retracting mechanism 72 is further reduced).

As described above, the sheet feeding device 13 according to the present embodiment includes the sheet tray 40 that can be inserted into and removed from the body of the image forming apparatus 1 (apparatus body). The sheet tray 40 has an engagement pin 45 that protrudes in the protruding direction (−X direction) orthogonal to the insertion direction (−Y direction) with respect to the body of the image forming apparatus 1. On the other hand, the body of the image forming apparatus 1 includes the guide 71 and the retracting mechanism 72. The guide 71 extends in the insertion directions (±Y directions), and guides the engagement pin 45 when the sheet tray 40 is inserted into the body of the image forming apparatus 1. The retracting mechanism 72 retracts the engagement pin 45 in the insertion direction (−Y direction) toward a specified position in the guide 71 in a state where the engagement pin 45 is engaged. The engagement pin 45 is held by the sheet tray 40 in a non-fixed manner to be movable in the orthogonal directions (±Z directions) orthogonal to the insertion direction (−Y direction) and the protruding direction (−X direction). Accordingly, such a configuration can be simplified, and the setting property at the time of inserting the sheet tray 40 into the body of the image forming apparatus 1 is enhanced.

In the present embodiment, the present disclosure is applied to the sheet feeding device 13 disposed in the lower stage inside the image forming apparatus 1. However, the present disclosure is also applicable to the sheet feeding device 12 disposed in the upper stage inside the image forming apparatus 1. The above-described embodiments of the present disclosure are applied to the sheet feeding devices 12 and 13 disposed in a monochrome image forming apparatus 1. However, for example, the present disclosure is also applicable to a sheet feeding device disposed in a color image forming apparatus. In the present embodiment, the present disclosure is applied to the sheet feeding devices 12 and 13 disposed inside the image forming apparatus 1. However, the present disclosure is also applicable to a sheet feeding device (e.g., a large-capacity sheet feeding bank) externally attached to the image forming apparatus 1. In this case, in the sheet feeding device, the body of the image forming apparatus 1 (the body of the sheet feeding device) into which a feeding tray is inserted and from which the feeding tray is removed is disposed independently of the body of the image forming apparatus. The above-described embodiments of the present disclosure are applied to the sheet feeding devices 12 and 13 disposed in the image forming apparatus 1 that employs electrophotography. However, the present disclosure is not limited to the above-described sheet feeding device. For example, the present disclosure is also applicable to a sheet feeding device disposed in an image forming apparatus that employs an inkjet method or a stencil printing machine. The sheet feeding mechanism 52 of the sheet feeding device 13 in the present embodiment is not limited to the feed-and-reverse roller (FRR) type using the sheet feed roller 53, the pickup roller 54, and the sheet separation roller 55, and various types such as a pad type can be used. Even in such a case, advantageous effects equivalent to the effects of the above-described embodiments can be obtained.

In the present embodiment, the engagement pin 45 is disposed only on the projection 44 on one end in the width direction of the projections formed on both ends in the width direction of the sheet tray 40, and one retracting unit 70 corresponding thereto is disposed in the body of the image forming apparatus 1. However, an engagement pin may be disposed also on the projection 44 on the other end in the width direction, and another retracting unit corresponding thereto may be disposed on the body of the image forming apparatus 1. In the present embodiment, the body of the image forming apparatus 1 is configured such that the engagement pin 45 is disposed to protrude in the horizontal direction in the sheet tray 40 and the groove width direction (orthogonal direction) of the guide 71 with which the engagement pin 45 engages is the vertical direction. However, the protruding direction of the engagement pin and the groove width direction (orthogonal direction) of the guide are not limited thereto, and for example, the apparatus body can be configured such that the engagement pin is disposed to protrude in the vertical direction in the sheet feed tray and the groove width direction (orthogonal direction) of the guide with which the engagement pin engages is the horizontal direction. In the present embodiment, the hole 44a into which the engagement pin 45 is inserted is formed in an oval shape. However, the hole 44a may be formed in a perfect circle shape. In this case, the hole diameter of the hole 44a is set to be larger than the outer diameter of the large-diameter portion 45b (insertion portion) of the engagement pin 45. Even in such a case, advantageous effects equivalent to the effects of the above-described embodiments can be obtained.

Note that embodiments of the present disclosure are not limited to the above-described embodiments and it is apparent that the above-described embodiments can be appropriately modified within the scope of the technical idea of the present disclosure in addition to what is suggested in the above-described embodiments. Further, features of components of the embodiments, such as the number, the position, and the shape are not limited the embodiments and thus may be preferably set.

In the present specification, the term “sheet” is defined as any sheet-like recording medium, such as general paper, coated paper, label paper, overhead projector (OHP) transparency, or a film sheet.

Aspects of the present disclosure are, for example, combinations of first to eighteenth aspects as follows.

### First Aspect

A sheet feeding device (e.g., the sheet feeding device 12, the sheet feeding device 13) includes a sheet tray (e.g., the sheet tray 40). The sheet tray is insertable into and removable from a body of an image forming apparatus (e.g., the image forming apparatus 1). The sheet tray includes an engagement pin (e.g., the engagement pin 45). The engagement pin protrudes in a protruding direction orthogonal to an insertion direction of the sheet tray with respect to the body of the image forming apparatus. The sheet feeding device further includes a guide (e.g., the guide 71) and a retracting mechanism (e.g., the retracting mechanism 72). The guide extends in the insertion direction of the sheet tray to guide the engagement pin when the sheet tray is inserted into the body of the image forming apparatus. The retracting mechanism retracts the engagement pin in an engaged state in the insertion direction of the sheet tray toward a specified position in the guide. The engagement pin is movable in an orthogonal direction orthogonal to both the insertion direction of the sheet tray and the protruding direction of the engagement pin and is held by the sheet tray in a non-fixed manner.

### Second Aspect

In the sheet feeding device (e.g., the sheet feeding device 12, the sheet feeding device 13) according to the first aspect, the sheet tray (e.g., the sheet tray 40) has a hole (e.g., the hole 44a) into which an insertion portion (e.g., the large-diameter portion 45b) of the engagement pin (e.g., the engagement pin 45) is inserted. The sheet tray holds the engagement pin to be slidable in the orthogonal direction with a clearance (e.g., the clearance C) formed in the orthogonal direction between the insertion portion and the hole.

### Third Aspect

In the sheet feeding device (e.g., the sheet feeding device 12, the sheet feeding device 13) according to the second aspect, the engagement pin (e.g., the engagement pin 45) is held in the sheet tray (e.g., the sheet tray 40) to be inclinable with respect to the protruding direction and slidable in the orthogonal direction.

### Fourth Aspect

In the sheet feeding device (e.g., the sheet feeding device 12, the sheet feeding device 13) according to the second aspect, the sheet tray (e.g., the sheet tray 40) holds the engagement pin (e.g., the engagement pin 45) with a clearance (e.g., the clearance D) formed in the insertion direction between the hole (e.g., the hole 44a) and the insertion portion (e.g., the large-diameter portion 45b).

### Fifth Aspect

In the sheet feeding device (e.g., the sheet feeding device 12, the sheet feeding device 13) according to fourth aspect, the engagement pin (e.g., the engagement pin 45) is held in the sheet tray (e.g., the sheet tray 40) to be inclinable with respect to the protruding direction and slidable in the insertion direction.

### Sixth Aspect

In the sheet feeding device (e.g., the sheet feeding device 12, the sheet feeding device 13) according to any one of the second to fifth aspects, the hole (e.g., the hole 44a) is formed such that a clearance (e.g., the clearance D) in the insertion direction is smaller than the clearance (e.g., the clearance C) in the orthogonal direction.

### Seventh Aspect

In the sheet feeding device (e.g., the sheet feeding device 12, the sheet feeding device 13) according to any one of the second to sixth aspects, the hole (e.g., the hole 44a) is an elongated or oval hole in which the orthogonal direction is a longitudinal direction of the hole and the insertion direction is a lateral direction of the hole.

### Eighth Aspect

In the sheet feeding device (e.g., the sheet feeding device 12, the sheet feeding device 13) according to any one of the second to seventh aspects, when a hole diameter of the hole (e.g., the hole 44a) in the longitudinal direction is R2, a hole diameter of the hole in the lateral direction is R3, and an outer diameter of the insertion portion of the engagement pin (e.g., the engagement pin 45) is R1, a relation of R2−R1>R3−R1 is established.

### Ninth Aspect

In the sheet feeding device (e.g., the sheet feeding device 12, the sheet feeding device 13) according to any one of the second to eighth aspects, the engagement pin (e.g., the engagement pin 45) has a small-diameter portion (e.g., the small-diameter portion 45a) guided by the guide (e.g., the guide 71) and a large-diameter portion (e.g., the large-diameter portion 45b) as the insertion portion.

### Tenth Aspect

The sheet feeding device (e.g., the sheet feeding device 12, the sheet feeding device 13) according to the ninth aspect further includes a retaining ring (e.g., the retaining ring 50) that is disposed in a circumferential groove (e.g., the circumferential groove 45b1) formed in the large-diameter portion (e.g., the large-diameter portion 45b) and has an outer diameter larger than the large-diameter portion.

### Eleventh Aspect

In the sheet feeding device (e.g., the sheet feeding device 12, the sheet feeding device 13) according to any one of the second to tenth aspects, the sheet tray (e.g., the sheet tray 40) has a wall (e.g., the restricting portion 44b) that restricts the movement of the engagement pin (e.g., the engagement pin 45) in a direction opposite to the protruding direction of the engagement pin.

### Twelfth Aspect

In the sheet feeding device (e.g., the sheet feeding device 12, the sheet feeding device 13) according to any one of the second to eleventh aspects, when a clearance between the engagement pin (e.g., the engagement pin 45) and the hole (e.g., the hole 44a) in the orthogonal direction is C and a clearance between the engagement pin and the guide (e.g., the guide 71) in the orthogonal direction is D, a relation of D<C is established.

### Thirteenth Aspect

In the sheet feeding device (e.g., the sheet feeding devices 12, the sheet feeding device 13) according to the twelfth aspect, when a hole depth of the hole (e.g., the hole 44a) is E, and a distance from an inner wall of the sheet tray (e.g., the sheet tray 40) in which the hole is formed to an outer wall of the body of the image forming apparatus (e.g., the image forming apparatus 1) in which the guide (e.g., the guide 71) is formed is F, a relation of D<C×F/E is established.

### Fourteenth Aspect

In the sheet feeding device (e.g., the sheet feeding device 12, the sheet feeding device 13) according to any one of the first to tenth aspects, the retracting mechanism (e.g., the retracting mechanism 72) retracts the engagement pin (e.g., the engagement pin 45) in the engaged state while drawing a trajectory (e.g., the trajectory S) having an arc shape around a fulcrum (e.g., the support shaft 73a) away from the guide (e.g., the guide 71).

### Fifteenth Aspect

In the sheet feeding device (e.g., the sheet feeding device 12, the sheet feeding device 13) according to any one of the first to fourteenth aspects, the retracting mechanism (e.g., the retracting mechanism 72) includes an arm (e.g., the first arm 73, the second arm 74) and a biasing member (e.g., the first tension spring 75, the second tension spring 76). The arm has an engagement groove (e.g., the engagement groove 73b) with which the engagement pin (e.g., the engagement pin 45) is engaged to be freely movable, and is rotatable around a fulcrum (e.g., the support shaft 73a) away from the guide (e.g., the guide 71). The biasing member biases the arm in a direction in which the engagement pin engaged with the engagement groove is retracted in the insertion direction.

### Sixteen Aspect

In the sheet feeding device (e.g., the sheet feeding device 12, the sheet feeding device 13) according to any one of the first to fifteenth aspects, the orthogonal direction is an up-and-down direction, and the sheet tray (e.g., the sheet tray 40) has a projection (e.g., the projection 44) that protrudes downstream from the sheet tray in the insertion direction. The engagement pin (e.g., the engagement pin 45) is on the projection. The guide (e.g., the guide 71) is a groove having the up-and-down direction as a groove width direction.

### Seventeen Aspect

In the sheet feeding device (e.g., the sheet feeding device 12, the sheet feeding device 13) according to any one of the first to sixteenth aspects, the sheet tray (e.g., the sheet tray 40) has a hole (e.g., the hole 44a) into which the insertion portion (e.g., the large-diameter portion 45b) of the engagement pin (e.g., the engagement pin 45) is inserted, and the insertion portion has a drum shape.

### Eighteen Aspect

An image forming apparatus (e.g., the image forming apparatus 1) includes the sheet feeding device (e.g., the sheet feeding device 12, the sheet feeding device 13) according to any one of the first to seventeenth aspects.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A sheet feeding device comprising:
a sheet tray insertable into and removable from a body of an apparatus, the sheet tray having an engagement pin that protrudes in a protruding direction orthogonal to an insertion direction of the sheet tray with respect to the body of the apparatus, is movable in an orthogonal direction orthogonal to both the insertion direction of the sheet tray and the protruding direction of the engagement pin, and is held by the sheet tray in a non-fixed manner;
a guide extending in the insertion direction of the sheet tray to guide the engagement pin when the sheet tray is inserted into the body of the apparatus; and
a retracting mechanism to retract the engagement pin in an engaged state in the insertion direction of the sheet tray toward a specified position in the guide.

2. The sheet feeding device according to claim 1,
wherein the sheet tray has a hole into which an insertion portion of the engagement pin is inserted, and
wherein the hole holds the engagement pin with a clearance formed in the orthogonal direction between the insertion portion and the hole.

3. The sheet feeding device according to claim 2,
wherein the engagement pin is held in the sheet tray to be inclinable with respect to the protruding direction and slidable in the orthogonal direction.

4. The sheet feeding device according to claim 2,
wherein the sheet tray holds the engagement pin with a clearance formed in the insertion direction between the hole and the insertion portion.

5. The sheet feeding device according to claim 4,
wherein the engagement pin is held in the sheet tray to be inclinable with respect to the protruding direction and slidable in the insertion direction.

6. The sheet feeding device according to claim 4,
wherein the clearance formed in the insertion direction is smaller than the clearance formed in the orthogonal direction.

7. The sheet feeding device according to claim 4,
wherein the hole is an elongated or oval hole, and the orthogonal direction is a longitudinal direction of the hole and the insertion direction is a lateral direction of the hole.

8. The sheet feeding device according to claim 4,
wherein when a hole diameter of the hole in a longitudinal direction of the hole is R2, a hole diameter of the hole in a lateral direction of the hole is R3, and an outer diameter of the insertion portion of the engagement pin is R1, a relation of R2−R1>R3−R1 is established.

9. The sheet feeding device according to claim 2,
wherein the engagement pin has a small-diameter portion guided by the guide and a large-diameter portion as the insertion portion having a larger diameter than a diameter of the small-diameter portion.

10. The sheet feeding device according to claim 9, further comprising a retaining ring disposed in a circumferential groove formed in the large-diameter portion,
wherein the retaining ring has an outer diameter larger than the large-diameter portion.

11. The sheet feeding device according to claim 9,
wherein the sheet tray has a wall to restrict a movement of the engagement pin in a direction opposite to the protruding direction.

12. The sheet feeding device according to claim 2,
wherein when a clearance between the engagement pin and the hole in the orthogonal direction is C, and a clearance between the engagement pin and the guide in the orthogonal direction is D, a relation of D<C is established.

13. The sheet feeding device according to claim 12,
wherein when a hole depth of the hole is E, and a distance from an inner wall of the sheet tray in which the hole is formed to an outer wall of the body of the apparatus in which the guide is formed is F, a relation of D<C×F/E is established.

14. The sheet feeding device according to claim 1,
wherein the retracting mechanism retracts the engagement pin in the engaged state while drawing a trajectory having an arc shape around a fulcrum away from the guide.

15. The sheet feeding device according to claim 1,
wherein the retracting mechanism includes:
an arm having an engagement groove with which the engagement pin is engaged to be freely movable, the arm being rotatable around a fulcrum away from the guide; and
a biasing member to bias the arm in a direction in which the engagement pin engaged with the engagement groove is retracted in the insertion direction.

16. The sheet feeding device according to claim 1,
wherein the orthogonal direction is an up-and-down direction,
wherein the sheet tray has a projection that protrudes downstream from the sheet tray in the insertion direction,
wherein the engagement pin is on the projection, and
wherein the guide is a groove having the up-and-down direction as a groove width direction.

17. The sheet feeding device according to claim 1,
wherein the sheet tray has a hole into which the insertion portion of the engagement pin is inserted, and
wherein the insertion portion has a drum shape.

18. An image forming apparatus comprising the sheet feeding device according to claim 1.
